(19) United States
(12) Patent Application Publication
(10) Pub. No.: US 2026/0180367 A1
(43) Pub. Date: Jun. 25, 2026

(54) IMPROVEMENT RELATING TO INDUCTIVE POWER TRANSFER

(71) Applicant: INTDEVICE LIMITED, Auckland (NZ)

(72) Inventors: Li Jun YU, Auckland (NZ); Hao HAO, Auckland (NZ)

(21) Appl. No.: 19/128,488

(22) PCT Filed: Nov. 24, 2023
(86) PCT No.: PCT/IB2023/061855

§ 371 Date: May 8, 2025

(30) Foreign Application Priority Data
Nov. 25, 2022 (NZ) 794920

(51) Int. Cl. H02J 50/12; B60L 53/12; H02J 3/16; H02J 3/18; H02M 3/00

(52) U.S. Cl. CPC H02J 50/12; H02J 3/16; H02J 3/18; H02M 3/015; B60L 53/12

(57) ABSTRACT

An inductive power transfer receiver. The receiver comprising an inductive power input circuit comprising a tuning circuit with a receiver coil, and a power control circuit for controlling the output power. A controller configured to control the power control circuit. The power control circuit comprises at least one variable reactance component that can be varied to control the output power provided to the load.

### FIELD OF THE INVENTION

The present specification relates to improvements in wireless power transfer (either wireless power transfer for charging or real-time wireless power transfer).

### BACKGROUND TO THE INVENTION

A typical inductive power transfer system, as shown in FIG. 1 comprises an inverter, primary and secondary tuning networks, primary and secondary coils, a secondary rectifier, and a load (such as a battery). Electrical power is transmitted wirelessly over air from the primary coil (transmitting) to a nearby secondary coil (receiving) via a magnetic field. The magnetic field is created by injecting an alternating current (Ipt) in the primary coil, and it induces an AC voltage in series with the secondary coil for power transfer.

The load has a power draw requirement. That power draw requirement might be constant, or dynamic. The power provided by the primary side, and received by the secondary side and then provided to the load should meet the power draw requirement. But that might not happen due to variations in power transmitted, power received, or power draw requirements.

### SUMMARY OF INVENTION

It is an object of the present invention to provide power control in an inductive power transfer system or receiver.

In a first aspect the present invention may be said to comprise an inductive power transfer receiver comprising: an inductive power input circuit comprising: a tuning circuit with a receiver coil, and a power control circuit for controlling the output power; and a controller configured to control the power control circuit, wherein the power control circuit comprises at least one variable reactance component that can be varied to control the output power provided to the load.

Optionally the output power comprises a power magnitude and a power factor, and controlling the output power comprises controlling the power magnitude and/or the power factor.

Optionally the power control circuit comprises at least a first reactance component in parallel with the receiver circuit coil for controlling the power magnitude.

Optionally power control circuit comprises at least a first and at least a second series reactance component in parallel with the receiver circuit coil for controlling the power magnitude and/or the power factor.

Optionally the power control circuit comprises a first and second and third series reactance component in parallel with the receiver circuit coil, the first and second reactance components for controlling the power factor and the third reactance component for controlling the power magnitude.

Optionally power control circuit forms part of the tuning circuit.

Optionally the turning circuit comprises a first tuning sub-circuit and a second tuning sub-circuit and the power control circuit is between the first and second tuning sub-circuits.

In a second aspect the present invention may be said to comprise an inductive power transfer receiver comprising an inductive power input circuit with a topology that can be modelled as a constant current source in series with a variable reactance component, wherein the variable reactance component can be varied to control the output power provided to the load.

In a third aspect the present invention may be said to comprise an inductive power transfer receiver comprising: an inductive power input circuit comprising: a first tuning circuit with a receiver coil, a second tuning circuit coupled to a load, or a rectifier coupled to a load, a power control circuit for controlling the output power coupled between the first and second turning circuit, and a controller configured to control the power control circuit, wherein the power control circuit comprises: at least first and second variable reactance components coupled between the first and second tuning circuits, and at least one third variable reactance component across the first and second reactance components where they couple to the second tuning circuits that can be varied to control the output power provided to the load.

In a fourth aspect the present invention may be said to comprise an inductive power transfer receiver comprising: an inductive power input circuit comprising: a first tuning circuit with a receiver coil, a second tuning circuit coupled to first turning circuit and a load, or a rectifier coupled to a load, a power control circuit for controlling the output power coupled between the first and second turning circuit, and a controller configured to control the power control circuit, wherein the power control circuit comprises at least one variable reactance component across the coupling between the first and second tuning circuits that can be varied to control the output power provided to the load.

In a fifth aspect the present invention may be said to comprise an inductive power transfer system comprising an inductive power transfer transmitting and an inductive power transfer receiver according to any one of the preceding claims.

Optionally, the inductive power transfer receiver or system according to any statement above comprises a rectifier for providing DC output power to a load.

In a sixth aspect the present invention may be said to comprise the circuit of FIG. 4.

In a seventh aspect the present invention may be said to comprise the circuit of FIG. 5A.

In an eighth aspect the present invention may be said to comprise a circuit as per any one of the models of FIG. 6A to 6F.

In a ninth aspect the present invention may be said to comprise the circuit of FIG. 7.

The second, third, fourth, fifth, sixth, seventh, eighth, and ninth aspects may comprise any one or more of the features of the first aspect described above.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner. Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

### BRIEF DESCRIPTION OF DRAWINGS

Embodiments will be described with reference to the following drawings, of which:

FIG. 1 shows an inductive power transfer system.

FIGS. 2A, 2B show two example circuits for a primary side transmitter for the inductive power transfer system.

FIGS. 3A, 3B show two example circuits for a secondary side receiver for the inductive power transfer system.

FIG. 4 shows in general form an inductive power transfer system with power control circuit for power control.

FIG. 5A shows an inductive power transfer system with a first embodiment of a power control circuit for power control.

FIG. 5B, 5C shows a graph demonstrating power control using the power control circuit of FIG. 5A.

FIGS. 6A to 6F show a Thevenin and Norton model of the power control circuit.

FIG. 7 shows an inductive power transfer system with a second embodiment of a power control circuit for power control.

### DETAILED DESCRIPTION

### 1. Overview Inductive Power Transfer Systems

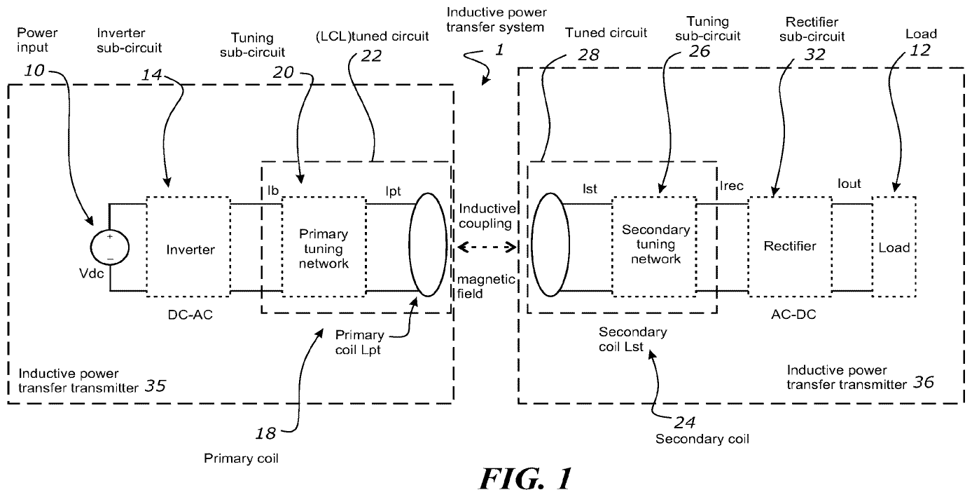

Referring to FIG. 1, power is transmitted from a transmitter (primary side) 35 to a receiver (secondary side) 36 of an inductive power transfer system 1. The power received at the receiver 36 is used to power a load 12, which could be any load that would benefit from inductive power transfer. For example, the load 12 could be a battery, and the transferred power can be used to charge the battery. Or the load 12 could be a device that is powered in real-time by the inductive power transfer system. Reference to power can mean a power magnitude, e.g. in Watts, and/or a power factor (e.g. in θ).

The load 12 has a power draw requirement. That power draw requirement might be constant, or dynamic. The power provided by the primary side 35, and received by the secondary side 36 and then provided to the load 12 should meet the power draw requirement. But that might not happen due to variations in power influencing factors such as power transmitted, power received, interaction between the primary 35 and secondary side 36 (e.g. mutual induction), ambient factors (e.g. temperature), load impedance changes, and/or load power draw requirements (magnitude and/or power factor). For example:
The power transmitted might be either too high or too low for the load 12, so that the received power does not meet the load power requirement.
The power transmitted meets the power draw requirement, but due to variations, such as changes in coil alignment, the power received at the transmitter 36 and provided to the load 12 does not meet the power draw requirement.
The power draw requirement varies (e.g. during a charging cycle of a battery load 12) and so the power transmitted and received does not meet the dynamic power draw requirement.

These are just some examples, and there might be other examples where the inductive power system 1 does not transmit, receive and/or or otherwise provide power that meets the load power draw requirement.

The present embodiments provide control so that the power received at the receiver and/or provided to the load can meet the load power draw requirement.

### 1.1 Overview of an Inductive Power Transfer System

An overview of a traditional inductive power transfer system 1 will first be described to provide background information to the present embodiments described herein. This provides context, although the embodiments described herein can be used in a variety of applications and not just the inductive power transfer system described with referring to FIG. 1. For example, the inductive power transfer system 1 (including the described embodiments and the sub-circuits that make up the inductive power transfer system) could be used in high power applications, such as, for example, wireless charging of electric vehicles in an industrial/commercial setting or alternatively in a domestic setting. But it could also cover use in wireless charging or real time power transfer to other electrical devices, such as robots, industrial equipment and the like.

FIG. 1 shows an overview of an inductive power transfer system 1 that wirelessly transfers power from a power input 10 to power a load 12. The inductive power transfer system comprises an inductive power transfer transmitter 35 (also termed “primary device”, “primary side”, “primary circuit”, “transmitter circuit”, “transmitter side”, or “transmitter module”) and an inductive power transfer receiver 36 (also termed “secondary device”, “secondary side”, “secondary circuit”, “receiver circuit”, “receiver side”, or “receiver module”). The inductive power transfer transmitter 35 is the portion of the inductive power transfer system 1 that wirelessly transfers power. The inductive power transfer receiver 36 is the portion of the inductive power transfer system 1 that wirelessly receives power.

Referring first to the inductive power transfer transmitter 35. The inductive power transfer system 1 in the inductive power transfer transmitter 35 comprises a power input 10. The power input 10 could be a voltage and/or current input. For example, the power input 10 could provide a DC voltage that may be generated from a power factor correction (PFC) unit, a DC-DC converter, a battery, or other types of DC sources. The inductive power transfer system 1 in the inductive power transfer transmitter 35 also comprises an inverter sub-circuit 14, used for converting the direct current of the power input into an alternating current output. The inverter sub-circuit 14 comprises at least one inverter, but there could be two or more. The inverter/s making up the inverter sub-circuit 14 could be a half-bridge, a full-bridge, another switching mechanism, or a combination of the above. The inverter sub-circuit 14 can be considered a modular standalone component. A skilled person would understand that an inverter sub-circuit 14 is not necessary if the power input already has a high frequency alternating current.

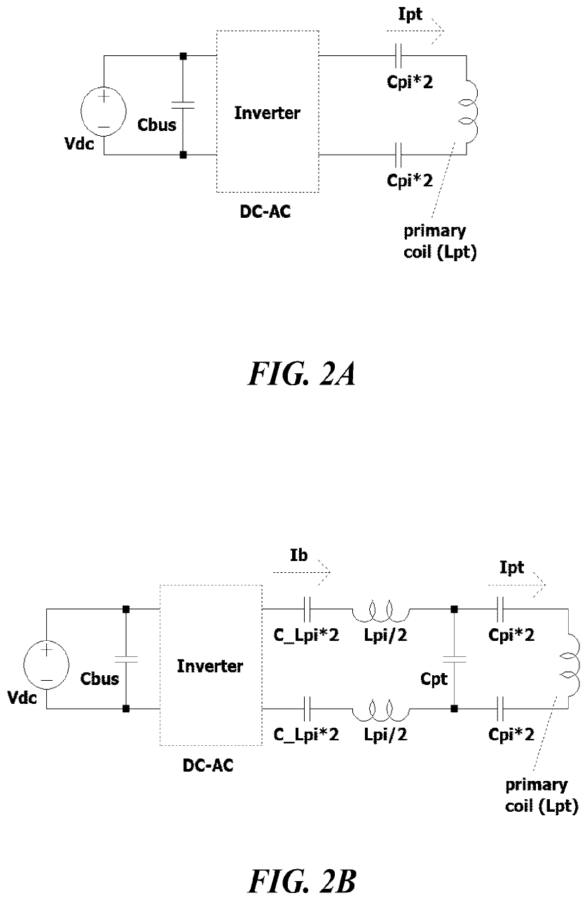

The inductive power transfer system 1 in the inductive power transfer transmitter also comprises a primary coil 18 (interchangeable with “transmitting coil”) used to wirelessly transmit power. The primary coil 18 may have multiple coils combined in series or in parallel but may be collectively referred to as “primary coil 18”. The primary coil 18 is tuned by a tuning sub-circuit 20 to such that the primary coil 18 and the tuning sub-circuit 20 form a tuned circuit 22. The tuned circuit 22 can be considered to be modular. The tuned circuit 22 may be series tuned circuit (see FIG. 2A for example) in which the tuning sub-circuit 20 has capacitors to tune the primary coil 18. Alternatively, the tuned circuit 22 may be a (parallel) LC tuned circuit in which the tuning sub-circuit 20 has capacitors to provide tuning. However it is preferable that the tuned circuit 22 is an LCL tuned circuit (see FIG. 2B for example). In an LCL tuned circuit 22, the tuning sub-circuit 20 provides the capacitors and inductors for the primary coil 18 to be LCL tuned circuit. The capacitors used for the LCL tuned circuit 22 are provided by the tuning sub-circuit 20. In addition to the primary coil 18, the inductors used for the LCL tuning 22 can be provided by the tuning sub-circuit 20.

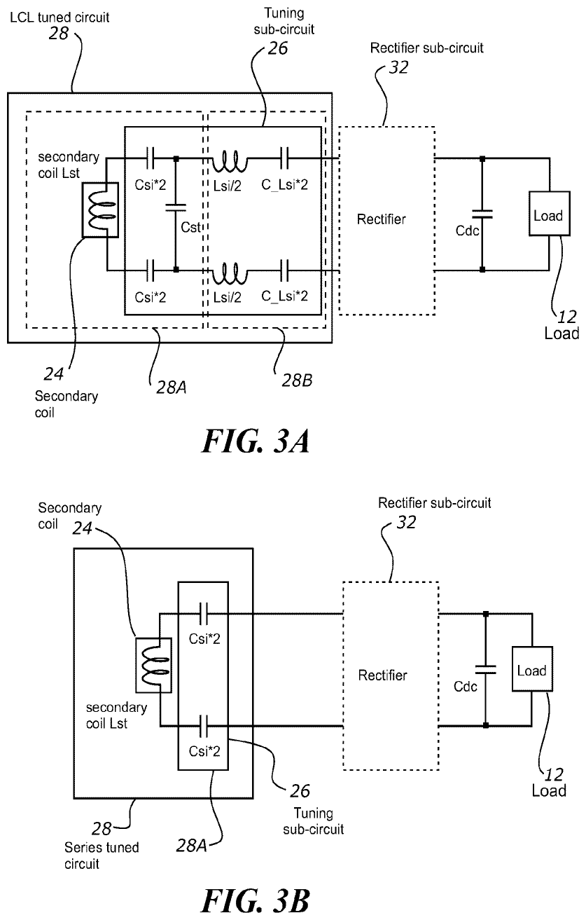

Now referring to the inductive power transfer receiver 36. The inductive power transfer system 1 in the inductive power transfer receiver 36 also comprises a secondary coil 24 (interchangeable with “receiving coil”) for receiving power that has been wirelessly transmitted from the primary coil 18. The secondary coil 24 may have multiple coils combined in series or in parallel but may be collectively referred to as “secondary coil 24”. Similar to the primary coil 18, the secondary coil 24 is tuned by a tuning sub-circuit 26 to form a tuned circuit 28. The tuned circuit 28 can be considered to be modular. The tuned circuit 28 may be an LCL tuned circuit (see FIG. 3A for example) in which the tuning sub-circuit 26 has inductors and capacitors to provide tuning. The tuning circuit of FIG. 3A could be considered to comprise two tuning sub-circuits as shown, themselves being tuning circuits in their own right—for example first part 28A could be a parallel LC tuned circuit and second part 28B could improve power factor. Alternatively, the tuned circuit 28 may be a (parallel) LC tuned circuit in which the tuning sub-circuit 26 has capacitors to provide tuning. However, it could be that the tuned circuit 28 is a series tuned circuit (see FIG. 3B for example). In a series tuned circuit 28, it is the tuning sub-circuit 26 that provide the capacitors for the secondary coil 24 to be series tuned. The inductive power transfer system 1 also comprises in the inductive power transfer receiver 36 a rectifier sub-circuit 32 for converting alternating current input into a direct current output (for a DC load). The rectifier sub-circuit 32 can be considered to be modular. The inductive power transfer system 1 also comprises in the inductive power transfer receiver 36 a load 12. A skilled person would understand that having a rectifier sub-circuit 32 is desirable in situations when providing direct current to the load 12 is desirable, but is not essential e.g. when AC loads are being powered.

1.2 Power Received at Load does not Meet Requirements

The inductive power transfer system 1 as above transmits power from the primary transmitter side 35 to the secondary receiver side 36 to power a load 12. The power transmitted from the primary side and received at the secondary receiver side and then provided to the load should meet a power draw that is required by the load (that is “power draw requirement”, which is the power magnitude required by the load). This can be achieved by controlling the power magnitude and/or power factor provided by the system. Meeting the power draw requirement this means that the power provided to the load 12 should be substantially the same as the power required by the load. If the power provided to the load is above or below the required load power draw, the provided power will be deemed not to meet to the required load power draw. (It will be appreciated that reference to “meet” the load power draw requirement, does not necessarily mean the provided power needs to meet it exactly, but alternatively just within sufficient tolerance for good operation. “Meet” can mean “meet within a suitable tolerance” e.g. such as within about +/−1%, or about +/−2% or about +/−3% or about +/−4% or about +/−5%).

But, as noted above, in practice this does not always happen. This may be due to variations in in power influencing factors such as the power transmitted, the power received, the interaction between the primary 35 and secondary side 36 (e.g. mutual induction), ambient factors (e.g. temperature), load impedance changes, and/or load power draw requirements. Some (non-exhaustive) reasons are briefly explained below.

Power transfer to the load 12 might vary from the power draw requirement due to coil misalignment/changes in the coupling factor, hereafter referred to as k. Inductive power transfer systems 1 transfer power optimally when the primary and secondary coils 18, 24 are properly aligned. Alignment may be such that the secondary coil 24 is within the optimal portion of the electromagnetic field produced by the primary coil 18. Misalignment between the primary and secondary coils 18, 24 can lead to less than optimal power transfer from the primary device 35 to the secondary device 36. That means that even if: a) the load power draw requirement is constant, and b) the transmitter 35 provides sufficient power to meet that power draw requirement, sufficient power might not make it from the transmitter 35 to the receiver/load 12 due to such misalignment. Misalignment can cover lateral misalignment (where the primary 18 and second 24 coils are do not have coincident axes) and/or separation misalignment, where the gap between the primary 18 and second 24 coils is either too great or too small.

Misalignment will be briefly explained further. Wireless power transfer systems operate over a wide range of the coupling factor, k. The change in k may be due to physical changes in alignment between the primary and secondary coils. Because in practice it may be difficult to perfectly align (laterally and/or separation-wise) both the transmitter and receiver coils, misalignment can occur, which can cause changes to k, such that it changes to a value different to (e.g. more or less than) the optimal value (or outside an optimal range). In addition, the ground clearance of a vehicle may change (e.g. due to vehicle loading, tyre pressure different vehicle types, etc), which can also contribute to a change in k due to change in coil separation away from the optimal spacing (this can be considered “misalignment” also). For example, k may typically change by a factor of around 2.5 for electric vehicle charging applications depending on the amount or degree of (mis) alignment.

In order to deliver power wirelessly, the primary circuit injects an AC current (Ipt) in the transmitting coil Lpt to establish a magnetic field, and the secondary coil should be placed in this magnetic field to receive power wirelessly.

More specifically, the magnetic field induces a voltage in series with the secondary coil. This voltage is typically measured with the secondary coil open circuited. Therefore, it is often known as the secondary coil open circuit voltage Voc.

$${V}_{o c} = ω \times {I}_{p t} \times k \times \sqrt{{L}_{p t} \times {L}_{s t}}$$

where ω=2nf and f is the operating frequency of the wireless power transfer system. Ipt is the primary coil current. Lpt and Lst are the primary and secondary coil self-inductances and k is the coupling factor or coefficient.

For a fixed passive secondary circuit, Voc determines the amount of power transferred from the primary to secondary. Therefore, if Voc can be kept constant against changes in k, the wireless system can operate at full power over a designated range of potential misalignment.

For simplicity, we can assume both the primary and secondary coil inductances do not change when there is misalignment present between the coils. In addition, we can assume the frequency is fixed when used for specific applications, such as EV charging. As a result, Voc may be directly controlled by the product of Ipt and k.

Therefore, in order to keep Voc constant against change in k, Ipt should change opposite to k. For example, if k changes by a factor of 2.5, the primary coil current Ipt should change by the same factor but in the opposite direction in order to keep Voc constant.

Alternatively, or additionally, power transfer to the load might not meet the power draw requirement due to dynamic changes in power draw requirement. An inductive power transfer system 1 should also control DC charging voltage and/or current during a charging cycle. More specifically, the charging current should be controlled from its maximum allowed value to near zero as the percentage of charge increases from 0% to 100%, as an example. For a passive secondary circuit, where the DC charging current is proportional to Voc, this means Voc should decrease by some additional amount, further extending the required range of Voc. So, even if the power provided by the primary 35 and received by the secondary 36 might meet the power draw requirements at the start of charging, as charging progresses the power might exceed the time-decreasing load power draw requirement, such that the power provided no longer meets the requirement.

Temperature of ambient air (or other ambient conditions) and/or the system can also alter operation of the system, such that the power provided to the load 12 may not meet the load power draw requirement.

The above can be complicated further in examples where a single primary side 35 transmits to multiple secondary side 36 receivers, each powering a different load 12. In these examples, the misalignment or k between the primary 35 and a secondary 36 might differ from that of the other secondary side receivers. The stage of charging cycle for each secondary side load might also differ amongst the multiple secondary side receivers.

Alternatively, or additionally, in some examples, the power transfer to the load may not meet the power draw requirement due dynamic changes in the load impedance. For example, the load impedance may change and become too inductive or capacitive, which can cause the power factor to worsen.

Differences in operation parameters due to manufacturing tolerances might also be mitigated through power control.

Alternatively, or additionally, power transfer to the load might not meet the power draw requirement due to a bad power factor (e.g. below about 0.7 or between 0.4 and 0.7 or below 0.4) at the transmitter, which means the transmitter no being able to provide enough power magnitude to the receiver side to meet power requirements.

1.3 Controlling Transmitter Power to Deal with Varying Power Requirements

As described above (or for other reasons), the provision of power by the inductive power transfer system 1 to the load 12 might not meet the load power draw requirements. Traditionally, to address this, the primary side power 35 may be controlled. For example, the primary side 35 controls its primary coil current 18 Ipt to: a) compensate for k changes due to misalignment, and/or b) lower the primary coil current to reduce DC charging current as a battery charges towards 100%.

However, relying only on the primary 35 to vary its coil current over a wide range can be challenging. This is particularly difficult or even impossible in some examples when one primary side 35 transmits to multiple secondary side 36 receivers, each powering a different load 12. In these examples, the primary side power may not be able to be sufficiently controlled to provide the required power to all the secondary side 36/loads 12, as the load power draw requirement for each secondary side is different and/or the factors influencing the received power at each of the loads may be different.

### 2. Secondary Circuit Power Control Solution

The present embodiments provide secondary side control 46 of power (both magnitude and/or power factor) such that the power provided to the load 12 can meet the load power draw requirement (i.e. the power magnitude required by the load). As described above, it will be appreciated that reference to “meet” the load power draw requirement, does not necessarily mean the provided power needs to meet it exactly, but alternatively just within sufficient tolerance for good operation. As previously explained, “meet” can mean “meet within a suitable tolerance” e.g. such as within about +/−1%, or about +/−2% or about +/−3% or about +/−4% or about +/−5%. For examples where charging is slower, the accuracy of the current can have a bigger tolerance, but the current may need to be constant or have small ripples to achieve this.

In addition, it might be desirable to control the power factor to minimise losses in a tuning circuit and/or to help improve the power factor of the inverter in the transmitter side and power control. Therefore, the present embodiments provide secondary side control 46 of power factor for these reasons also.

Power factor and power magnitude are generally separate requirements and so the drivers for controlling each can be different. Power magnitude is controlled to meet the power draw requirement, and power factor is controlled for efficiency and stability. But in practice there can be an interrelationship between the two for practical reasons. This is because of the following. A poor power factor at the receiver side may require more current in the transmitter coil to satisfy the output power magnitude (load power draw requirement), and therefore a poor power factor at receiver side may add stress to the transmitter side. A poor power factor may also cause large reactive current to circulate in tuning circuits and the secondary/receiver for a non-series tuned secondary/receiver coil, which can generate excessive heat and higher interference. This may limit the ability of delivering required power safely and reliably. Sometimes, to manage the heat issue, the delivered power magnitude has to be reduced-which may mean the power draw requirement is not met. So, meeting the power draw requirements might mean controlling not just power magnitude, but power factor also.

The present embodiments relate to secondary circuit 46 topologies that adjust the secondary power (the power magnitude and/or the power factor) to provide the required power at the load, even due to variations in power influencing factors. Examples of variations in the power influencing factors include:
The power provided by the primary side.
The power received from primary side, which may vary from the required power due to misalignment or other disturbances.
The load power draw requirement.
Load impedance changes.
Interaction between the primary and secondary sides.
Ambient factors.

In effect, and among other things, the circuit topologies enable power magnitude and/or power factor correction due to variation in power influencing factors.

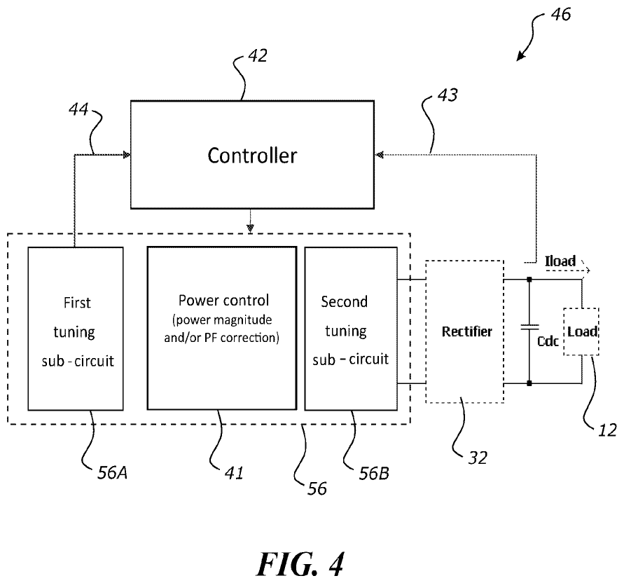

FIG. 4 shows in general topology the present embodiments of a secondary circuit 46 (modified from the secondary circuit 36 previously discussed) for an inductive power transfer system 1. As with the previously described examples, the secondary circuit 46 has a tuning circuit (inductive power input circuit) 56. The tuning circuit 56 can nominally be divided into a first tuning sub circuit 56A and a second tuning sub circuit 56B. Each tuning sub circuit can be deemed to be a tuning circuit on their own, or jointly be considered a tuning circuit 56. The secondary circuit 46 also comprises a secondary power control circuit 41 disposed between the first and second tuning subcircuits 56A, 56B. The power control circuit 41 can form part of an overall tuning circuit 56, or can be considered to be a circuit in between two tuning circuits 56A, 56B. The power control circuit 41 is for controlling the power provided to the load 12 (that is, controlling the power magnitude to the load and/or the correct the power factor of the load), as will be described further below.

A controller 42 is provided which receives input 43 from the load side 12 (output side) of the secondary circuit 46 indicating the power magnitude on the load side, and/or receives input 44 from the coil side (input side) of the secondary circuit 46 indicating the power factor. The controller 42 may send one or more control signals 45 to the power control circuit 41 to adjust the power (magnitude and/or power factor), so that the provided power is capable of meeting the required draw power for the load 12 (that is the required power magnitude and the power factor is the desired power factor)-typically 1 or close to 1, although that is not essential.

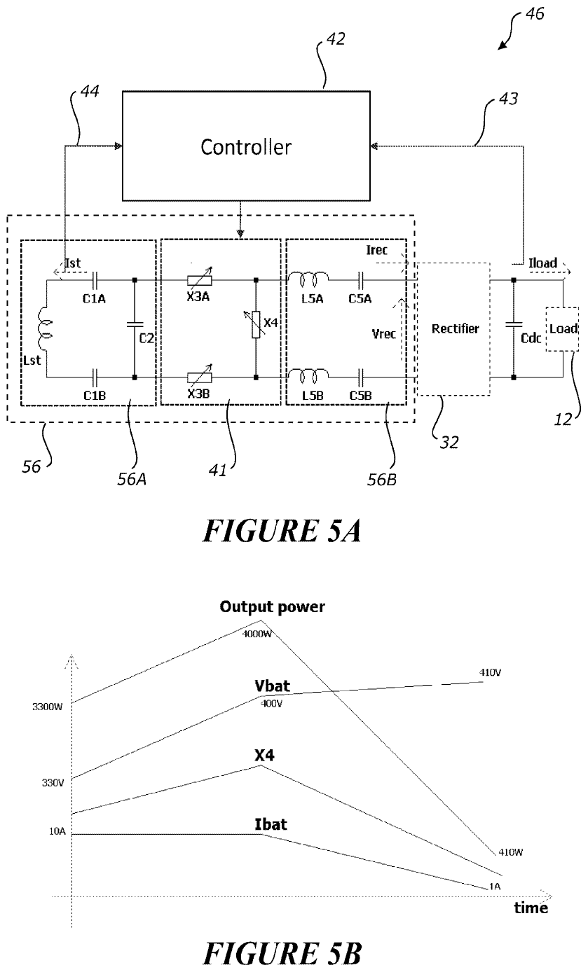

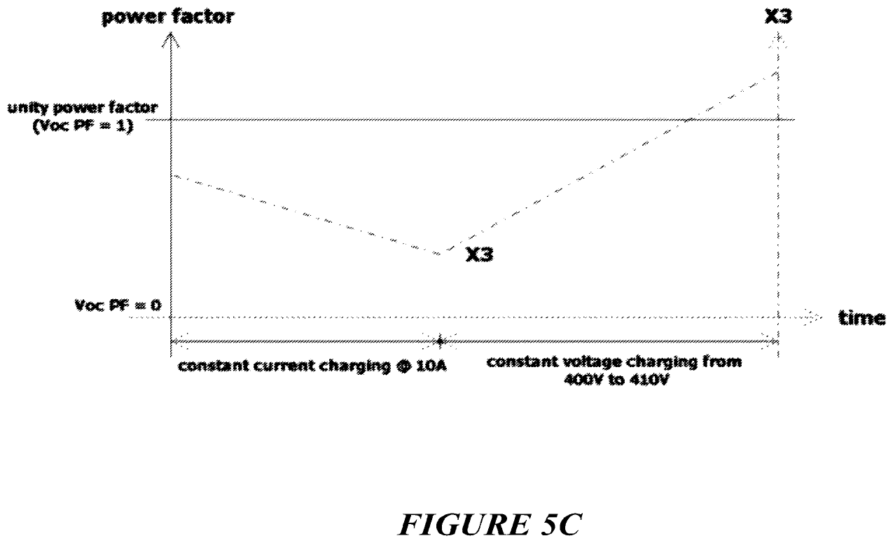

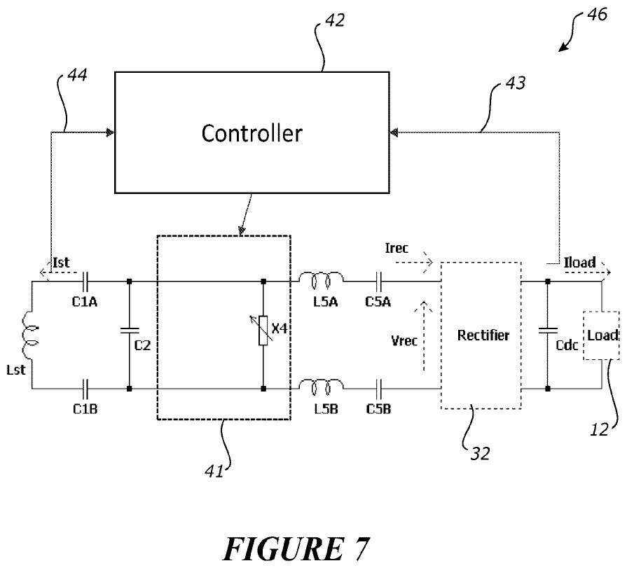

The power control circuit 41 comprises one or more variable reactance components (these may be for example variable capacitors and or inductors (see FIGS. 5A and 7 and related description for examples)). The one or more variable reactance components may work in combination with the two tuning subcircuits 56A, 56B to adjust the power magnitude and/or power factor. In the case where the power control circuit 41 controls power factor and controls power magnitude, the control of the power factor is independent of and does not affect the control of the power magnitude. This will be explained later in more detail.

### 3. First Embodiment

FIG. 5A shows one nonlimiting example of the secondary circuit 46 with a power control circuit 41. It will be noted that the tuning subcircuits 56A, 56B described are not limiting, and provided by way of example only. Also, the power control circuit 41 is by way of example only.

In this example, the first tuning sub circuit 56A comprises the secondary receiving coil 24, a first series capacitor C1A, a second series capacitor C1B coupled to the power control circuit, and a parallel capacitor C2. This forms a parallel LC turning circuit. The second tuning subcircuit 56B comprises a first series inductor L5A, second series inductor L5B coupled to the output of the power control circuit 41. The second tuning subcircuit 56B may optionally further comprise a first series capacitor C5A and a second series capacitor C5B respectively in series with the first and second series inductors L5A, L5B, and coupled to the rectifier. The rectifier, parallel capacitor Cdc on the output in the load are as previously described.

The power control circuit 41 may comprise two power factor correction reactive components X3A, X3B (in this example the two power factor correction reactive components X3A, X3B are inductors but could in other examples be capacitors) and series between the first tuning subcircuit 56A and the second tuning sub circuit 56B. In other examples, a single power factor correction reactive component may be present. This may be referred to as X3 (as discussed below). Some such examples may involve X3A, X3B being combined into a single power factor correction reactive component. As with the previous example, the single power factor correction reactive component may be either inductive or capacitive.

The power control circuit 41 also comprises a power (magnitude) control reactive component X4 (in this example, X4 is an inductor, but it will be appreciated that in other examples, it may be a capacitor). The power (magnitude) control reactive component X4 is positioned between the power factor reactive component X3A, X3B and the inductors L5A, L5B.

An example of operation of the power control circuit will now be described with reference to FIG. 5B. If a load 12 (in this case a battery) is being charged by the inductive power transfer system 1, the voltage will slowly increase from an initial value (this may be a minimum value if the battery is flat), towards the maximum value (i.e. the battery being 100% charged). For example, an EV battery may change from 330v to 410V during a charge. The charging current is normally controlled to be constant at 10A during the first phase of charging (battery voltage less than 400V) and slowly decrease towards near zero during the second phase of charging (for example, battery voltage higher than 400V). Such changes indicate the charging power level can change significantly during a charging cycle. Depending on tuning parameters, output power may change in the same direction as the reactance of X4 changes; increasing the reactance of X4 may cause the output power to increase. In examples where X4 is an inductor, for the first charging phase, the inductance X4 could be slowly increased to match the increasing output power demand. For the second phase of charging, the inductance X4 could be decreased to match the decreasing charging power demand. This is described below. A typical range of an inductive X4 can be (without limitation) from about 5 uH to about 100 uH. A typical range of a capacitive X4 can be (without limitation) from about 10 nF to about 150 nF.

The proposed topology 41 also acts as a low pass filter, for example, where X4 is capacitive, and/or X3A, X3B are inductive, they may act to filter or block high order harmonics from reaching the secondary coil 24. This improves the EMI performance of the system 1 compared to a conventional tuned secondary.

In addition, variable components X3A and X3B may be adjusted to improve the power factor of Voc (open-circuit induced voltage) during power delivery. The left side of X3 (representing both X3A and X3B) is the power source which is the first tuning sub-circuit 56 in FIG. 5A. As such, X3 is for power factor correction so “the load of the power source” is largely real, where “the load of the power source” is circuit to the right side of first tuning sub-circuit 56, including X3. Due to the variation of X4 and the load, the impedance of the load of the power source changes. A unity power factor helps to optimise/minimise currents in both the primary and secondary coils, leading to a more efficient system. If the first tuning sub circuit 56A is tuned as a current source, adjusting X3A and X3B does not affect power level. This allows Voc power factor and power level to be controlled independently. For other types of first tuning sub circuit 56A, power level and Voc power factor may both change with X3A and X3B, potentially making the control algorithm more complicated.

An example of operation of the power control circuit with respect to controlling power factor is described with reference to FIG. 5C. The power magnitude change over time is similar to that described in relation to FIG. 5B. A near unity power factor for Voc may be achieved by varying X3 during a charging cycle. A well parallel tuned circuit 56A may have such conditions: if the impendence of the combination of Lst, C1A and C1B is jX, then C2 should be-jX or very close to-jX. By adjusting X3A and X3B, to make the impedance at the right side of C2 (Imp_c2right) to be jX, then the power factor of Voc can be unity or very close to unity. The smaller of the difference between Imp_c2right and jX, the better the power factor may be.

Components L5A, L5B, C5A and C5B may also be tuneable or adjustable. Changing the values of these components may also affect power factor of Voc and power level. The exact effect of changes to these components may depend on the whole tuning network. Adjusting one or multiple components of X3A, X3B, X4, L5A, L5B, C5A and C5B may also change the impedance of the receiver side, which could help improve the inverter's power factor in the transmitter and transmitter's power delivery by reflecting the adjusted impedance of the receiver side to the transmitter side.

### 4. Thevenin and Norton Model

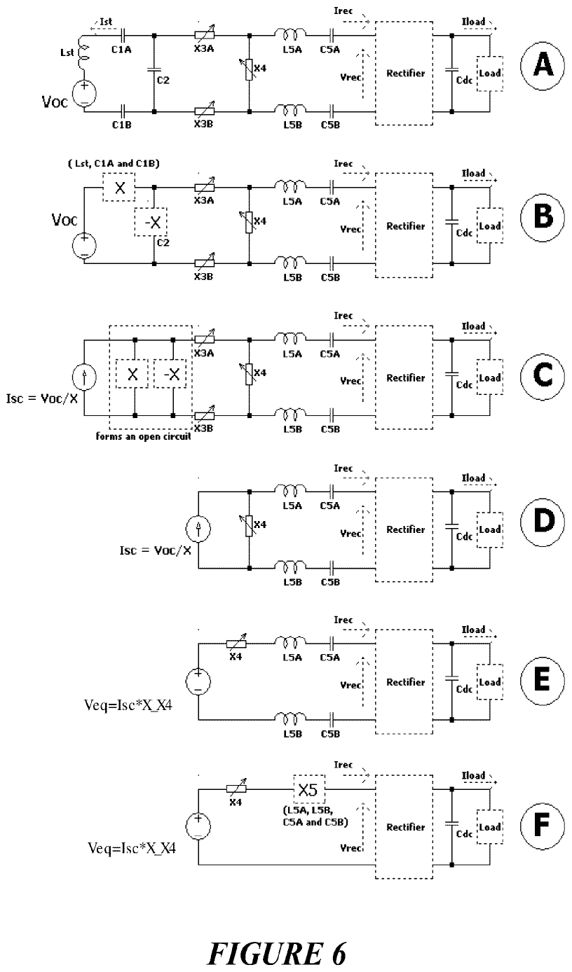

Using a Thevenin and Norton model, the concept of power magnitude control using X4 as described in the first embodiment of FIG. 5A is explained in FIGS. 6A to 6F, which show examples of how the proposed circuit of the first embodiment can be simplified and reduced to a series tuned equivalent circuit. Furthermore, this may provide a model that can be used to determine alternative solution embodiments, some of which are set out later.

FIG. 6A shows an example of an original or starting circuit A. In these examples, Voc represents the open-circuit induced voltage in series with the secondary coil. The combined impedance of Lst, C1A and C1B is designed to be +X and the impedance of C2 is designed to be −X, as shown in circuit B, which is shown in FIG. 6B. Using Norton transformation, Voc and +X can be transformed into a parallel connection of Isc (Isc=Voc/X) and +X, as shown in circuit C, which is shown in FIG. 6C. Placing +X and −X in parallel creates an infinite impedance because the equivalent impedance is −X*X/(X−X). (If the denominator is zero, the combined impedance is infinity). In this example, X3A and X3B are in series with the current source and therefore do not affect the value of the current and so can be removed from circuit C. Thus we arrive at circuit D which is shown in FIG. 6D.

A parallel connection of current source Isc and X4 can be transformed into a voltage source Veq in series with X4 using Thevenin transformation, as shown in circuit E, which is shown in FIG. 6E, and using the equation:

$$Veq = Isc * X\_X4 = Voc / X * X\_X4 \qquad ( 1 )$$

Where X_X4 is the reactance of the component X4. If we assume no primary side control (Voc is fixed), we can see that changing the reactance of X4 (X_X4) changes Veq. Since Veq drives the DC load through X4 and X5 (where X5 is L5A, C5A, L5B and C5B combined) in circuit F, it is understood that the DC power magnitude can be controlled by changing the reactance of X4 (X_X4). Generally speaking, reducing the reactance of X4 (X_X4) will reduce DC power magnitude, and vice versa. X4 and X5 can be fully or partially series tuned to boost the output current.

In some examples, X3 can also be added for power factor control, as described with reference to FIGS. 5A and 5B. The equation (1) for Veq does not require X3, so the value of X3 does not affect Veq, which also means X3 does not affect the power magnitude control by X4. That is, X3 is independent of X4, and X3 can be added and can be varied to control power factor independently of X4 being varied to control power magnitude. This can be explained as follows:

The combined impedance of the right side of X3 (including X4, L5A, L5B, C5A, C5B, rectifier, Cdc and load) can be expressed as:

$$R\_load + jX\_load \qquad ( 2 )$$

The total reactance of Lst, C1A and C1B is jX1, and reactance of C2 is-jX1. Then the reactance of X3 (X_X3) can be expressed as:

$$j ( X 1 - X\_load ) \qquad ( 3 )$$

so the combined impedance for the right side of first sub-tuning circuit can be expressed as:

$$R\_load + jX 1 \qquad ( 4 )$$

So, as will be understood, the load for the open-circuit voltage becomes real, a unit power factor, which minimises current in the secondary/receiver coil 24. The unity power factor can be maintained against variations in X4 and the load by varying the reactance of X3 (X_X3) according to the principle described above. More specifically, due to the changes of X4 and/or load 12, the variation of the combined impedance of the right side of X3 can be expressed as:

$$ΔR\_load + j ΔX\_load \qquad ( 5 )$$

As such, the variation in the reactance of X3 (X_X3) may be close to the following:

$$j ( X 1 - ΔX\_load ) \qquad ( 6 )$$

This can cancel out the reactance change from the right side of X3. Thus the variation the impedance of the right side of first Sub-tuning circuit is ΔR_load, which is only Real resistance change.

### 5. Second Embodiment

While a power factor reactance component X3 is preferred, it can be seen from FIG. 6A to 6F that resultant model shows the delivered power to the load is independent of the power factor reactance component X3, such that controlling power factor using those reactance component does not affect control of the power magnitude. Therefore, X3 may not be essential for control of the output power magnitude only. For certain applications or examples where the secondary power factor does not change significantly (such as in low power applications), or where a poor secondary power factor does not cause significant losses in the secondary coil or where the secondary power factor is good without X3, X3 could be omitted as shown in FIG. 7. In these applications or examples, only the power magnitude would be controlled.

### 6. Variations

The above embodiments have been described with a rectifier to provide for a DC load (with DC power requirements). In examples which utilise an AC load (that has AC power requirements), a rectifier may not be required. As such, these examples can comprise any of the embodiments above, but without a rectifier.

In the above embodiments, the second side circuit 46 has been described as a receiver circuit for an inductive power transfer system, however in some examples it could be used as an input for any type of power system.

The present embodiments make primary side control easier. In traditional systems, if the coupling factor k or other influencing factors change, large changes are typically required by the primary side. The present embodiments allow for control of power requirements with the secondary side to enable smaller changes (which in some examples includes no changes) by the primary side.

### TERMINOLOGY AND DEFINITIONS

The phrases ‘computer-readable medium’ or ‘machine-readable medium’ as used in this specification and claims should be taken to include, unless the context suggests otherwise, a single medium or multiple media. Examples of multiple media include a centralised or distributed database and/or associated caches. These multiple media store the one or more sets of computer executable instructions. The phrases ‘computer-readable medium’ or ‘machine-readable medium’ should also be taken to include any medium that is capable of storing, encoding or carrying a set of instructions for execution by a processor of a computing device and that cause the processor to perform any one or more of the methods described herein. The computer-readable medium is also capable of storing, encoding or carrying data structures used by or associated with these sets of instructions. The phrases ‘computer-readable medium’ and ‘machine readable medium’ include, but are not limited to, portable to fixed storage devices, solid-state memories, optical media or optical storage devices, magnetic media, and/or various other mediums capable of storing, containing or carrying instruction(s) and/or data. The ‘computer-readable medium’ or ‘machine-readable medium’ may be non-transitory.

The term ‘comprising’ as used in this specification and claims means ‘consisting at least in part of’ or ‘including, but not limited to’ such that it is to be construed in an inclusive sense as opposed to an exclusive or exhaustive sense. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

The term ‘and/or’ means ‘and’ or ‘or’, or both.

The use of ‘(s)’ following a noun means the plural and/or singular forms of the noun.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

In the above description, specific details are given to provide a thorough understanding of the embodiments. However, it will be understood by one of ordinary skill in the art that the embodiments may be practiced without these specific details. For example, software modules, functions, circuits, etc., may be shown in block diagrams in order not to obscure the embodiments in unnecessary detail. In other instances, well-known modules, structures and techniques may not be shown in detail in order not to obscure the embodiments.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc., in a computer program. When a process corresponds to a function, its termination corresponds to a return of the function to the calling function or a main function.

Aspects of the systems and methods described above may be operable on any type of general purpose computer system or computing device, including, but not limited to, a desktop, laptop, notebook, tablet, smart television, gaming console, or mobile device. The term “mobile device” includes, but is not limited to, a wireless device, a mobile phone, a smart phone, a mobile communication device, a user communication device, personal digital assistant, mobile hand-held computer, a laptop computer, wearable electronic devices such as smart watches and head-mounted devices, an electronic book reader and reading devices capable of reading electronic contents and/or other types of mobile devices typically carried by individuals and/or having some form of communication capabilities (e.g., wireless, infrared, short-range radio, cellular etc.).

Aspects of the systems and methods described above may be operable or implemented on any type of specific-purpose or special computer, or any machine or computer or server or electronic device with a microprocessor, processor, microcontroller, programmable controller, or the like, or a cloud-based platform or other network of processors and/or servers, whether local or remote, or any combination of such devices.

Furthermore, embodiments may be implemented by hardware, software, firmware, middleware, microcode, or any combination thereof. When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the above description, a storage medium may represent one or more devices for storing data, including read-only memory (ROM), random access memory (RAM), magnetic disk storage mediums, optical storage mediums, flash memory devices and/or other machine or computer readable mediums for storing information.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, circuit, and/or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

One or more of the components and functions illustrated the figures may be rearranged and/or combined into a single component or embodied in several components without departing from the scope of the disclosure. Additional elements or components may also be added without departing from the scope of the disclosure. Additionally, the features described herein may be implemented in software, hardware, as a business method, and/or combination thereof.

In its various aspects, embodiments of the disclosure can be embodied in a computer-implemented process, a machine (such as an electronic device, or a general purpose computer or other device that provides a platform on which computer programs can be executed), processes performed by these machines, or an article of manufacture. Such articles can include a computer program product or digital information product in which a computer readable storage medium containing computer program instructions or computer readable data stored thereon, and processes and machines that create and use these articles of manufacture.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment of the invention disclosed herein.

This disclosure may also be said broadly to consist in the parts, elements and features referred to or indicated in this disclosure, individually or collectively, and any or all combinations of any two or more said parts, elements or features, and where specific integers are mentioned herein which have known equivalents in the art to which this disclosure relates, such known equivalents are deemed to be incorporated herein as if individually set forth.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

1. An inductive power transfer receiver comprising
an inductive power input circuit comprising:
a tuning circuit with a receiver coil, and
a power control circuit for controlling the output power,
and
a controller configured to control the power control circuit,
wherein the power control circuit comprises at least one variable reactance component that can be varied to control the output power provided to the load.

2. An inductive power transfer receiver according to claim 1 wherein the output power comprises a power magnitude and a power factor, and controlling the output power comprises controlling the power magnitude and/or the power factor.

3. An inductive power transfer receiver according to claim 1 or 2 wherein the power control circuit comprises at least a first reactance component in parallel with the receiver circuit coil for controlling the power magnitude.

4. An inductive power transfer receiver according to claim 1 or 2 wherein power control circuit comprises at least a first and at least a second series reactance component in parallel with the receiver circuit coil for controlling the power magnitude and/or the power factor.

5. An inductive power transfer receiver according to claim 4 wherein power control circuit comprises a first and second and third series reactance component in parallel with the receiver circuit coil, the first and second reactance components for controlling the power factor and the third reactance component for controlling the power magnitude.

6. An inductive power transfer receiver according to any preceding claim wherein power control circuit forms part of the tuning circuit.

7. An inductive power transfer receiver according to any one of claims 1 to 6 wherein the turning circuit comprises a first tuning sub-circuit and a second tuning sub-circuit and the power control circuit is between the first and second tuning sub-circuits.

8. An inductive power transfer receiver comprising:
an inductive power input circuit with a topology that can be modelled as a constant current source in series with a variable reactance component,
wherein the variable reactance component can be varied to control the output power provided to the load.

9. An inductive power transfer receiver comprising
an inductive power input circuit comprising:
a first tuning circuit with a receiver coil,
a second tuning circuit coupled to
a load, or
a rectifier coupled to a load,
a power control circuit for controlling the output power coupled between the first and second turning circuit, and
a controller configured to control the power control circuit,
wherein the power control circuit comprises:
at least first and second variable reactance components coupled between the first and second tuning circuits, and
at least one third variable reactance component across the first and second reactance components where they couple to the second tuning circuits
that can be varied to control the output power provided to the load.

10. An inductive power transfer receiver comprising
an inductive power input circuit comprising:
a first tuning circuit with a receiver coil,
a second tuning circuit coupled to first turning circuit and
a load, or
a rectifier coupled to a load,
a power control circuit for controlling the output power coupled between the first and second turning circuit, and
a controller configured to control the power control circuit,
wherein the power control circuit comprises at least one variable reactance component across the coupling between the first and second tuning circuits that can be varied to control the output power provided to the load.

11. An inductive power transfer system comprising an inductive power transfer transmitting and an inductive power transfer receiver according to any one of the preceding claims.

12. An inductive power transfer receiver or system according to any preceding claim further comprising a rectifier for providing DC output power to a load.
